(19) United States
(12) Patent Application Publication
(10) Pub. No.: US 2004/0053689 A1
(43) Pub. Date: Mar. 18, 2004

(54) Demonstration display method for game machine, and game machine for demonstration

(76) Inventors: Toshiyuki Hosaka, Matsumoto-shi (JP); Shinichi Tsukagoshi, Shiojiri-Shi (JP)

Correspondence Address: HARNESS, DICKEY & PIERCE, P.L.C., P.O. BOX 828, BLOOMFIELD HILLS, MI, 48303, US

(21) Appl. No.: 10/609,337

(22) Filed: Jun. 27, 2003

(30) Foreign Application Priority Data
Jun. 28, 2002 (JP) 2002-191087
Mar. 24, 2003 (JP) 2003-080725

(51) Int. Cl. A63F 13/00; A63F 9/24

(52) U.S. Cl. 463/31

(57) ABSTRACT

A demonstration display method is provided for a game machine which can display various changing display screens of different presentation patterns in a short time, and which a player can enjoy the game machine sufficiently. In the demonstration display method, changing display screens are displayed in which each changing display screen corresponds to a presentation pattern determined on the basis of a predetermined condition from among a plurality of presentation patterns. The demonstrating sequence of the individual presentation patterns is specified on the basis of sequence information in which the demonstrating sequence of the respective presentation patterns is registered, and the changing display screens corresponding to the respective presentation patterns are successively displayed on the display unit in accordance with the specified demonstrating sequence.

### BACKGROUND OF THE INVENTION

1. Technical Field

The present invention relates to a demonstration display method and a game machine, both of which are for displaying changing display screens corresponding to individual presentation patterns for a demonstration.

2. Related Art

In a case, for example, where a game machine (pachinko or “Japanese upright pinball game” machine by way of example) of a new model is demonstrated in a new product exhibition or a showroom, the pachinko machine which can be installed in a pachinko parlor or the like (for example, the game machine disclosed in JP-A-2001-314597; also referred to below as the “actual machine”) is installed as a pachinko machine for a demonstration so as to be capable of playing a game, and a visitor is allowed to actually play the game. In this case, in a present-day pachinko machine, various animations (changing display screens) are displayed on a display unit (special pattern display device) at the center of a board in conjunction with game states, and a big hit prize hole (attacker) is opened in accordance with the display contents (presentation patterns) of the animations. Accordingly, the presentation patterns of the animations greatly affect the popularity of the pachinko machine. Therefore, the owner of the pachinko parlor, or the like judges whether the pachinko machine is good or bad, by actually causing the pachinko machine to display the animations of the various presentation patterns in such a way that the player actually plays the game with the pachinko machine of a new model installed for the demonstration.

However, conventional demonstration methods have some problems as follows. In a demonstration display method for displaying animations in the conventional demonstration method, the animations of various presentation patterns are displayed by employing an actual machine as a pachinko machine for a demonstration. In this case, in the present-day pachinko machine, the numerous presentation patterns of, for example, up to 300 or more are prepared beforehand in order to prevent a player from being bored, and a probability at which the presentation pattern is displayed differs with every presentation pattern. In the actual machine, the presentation patterns used for displaying the animation when a shot ball has hit a start chucker, is sequentially determined on the basis of a predetermined lottery probability (that is, the probability at which the animation corresponding to each presentation pattern is displayed). In the conventional demonstration display method using the actual machine as the pachinko machine for the demonstration, therefore, the presentation pattern which is displayed at a high probability (for example, an ordinary changing display) is frequently displayed, whereas the presentation pattern which is displayed at a low probability and which is especially attractive for the pertinent pachinko machine (for example, premium reach) is not easily displayed. This leads to the problem that the more popular animation presentation patterns are rarely seen.

Accordingly, a game needs to be continued for a long time for the purpose of displaying all the animations of the different presentation patterns. In fact, it is difficult to display all the animations corresponding to the respective presentation patterns, even when the game is continued over several days. On the other hand, there is also considered a demonstration display method in which all the animations are automatically displayed in a predetermined sequence irrespective of the game. Such a demonstration display method, however, has the problem that the full enjoyment of the pachinko machine cannot be sufficiently experienced. With the demonstration display method in which the sequence of the demonstration display is predetermined, when demonstration displays have been simultaneously started on a plurality of pachinko machines by way of example, displayed animations occur simultaneously on all the pachinko machines. Accordingly, there is also the problem that, since the concurrent operations are greatly different from the real operations of the pachinko machines, the demonstrator recognizes the fact that the animations are displayed in the predetermined sequence.

The present invention has been made in view of such problems, and one object is to provide a demonstration display method for a game machine and a game machine for a demonstration, for the purpose of displaying all of the various changing display screens of different presentation patterns in a short time and allowing a player to sufficiently experience the enjoyment of the game machine. Another object is to provide a demonstration display method for a game machine and a game machine for a demonstration that allows a demonstrator to experience a game with a feeling equivalent to that of an actual game, without causing the participant to recognize the fact that the changing display screens are displayed in a predetermined sequence.

### SUMMARY

In order to accomplish the above objects, in a demonstration display method for a game machine according to the present invention, a changing display screen corresponding to a presentation pattern determined on the basis of a predetermined condition from among a plurality of presentation patterns is displayed on a display unit. A demonstrating sequence of the individual presentation patterns is specified on the basis of sequence information where the demonstrating sequence of the respective presentation patterns is recorded. The changing display screens corresponding to the respective presentation patterns are successively displayed on the display unit in accordance with the specified demonstrating sequence.

A game machine for a demonstration according to the present invention includes a display unit that displays a changing display screen corresponding to a rendering pattern determined on the basis of a predetermined condition from among a plurality of rendering patterns. The game machine also includes a storage unit which stores therein sequence information where a demonstrating sequence of the individual rendering patterns is recorded. The game machine further includes a control unit which causes the display unit to successively display the changing display screens corresponding to the respective rendering patterns, in accordance with the demonstrating sequence specified on the basis of the sequence information.

With the demonstration display method for a game machine and the game machine for a demonstration, the changing display screens corresponding to the respective presentation patterns are successively displayed on the display unit in accordance with the demonstrating sequence specified on the basis of the sequence information. Thus, the changing display screens which are displayed at low probabilities are permitted to be reliably displayed in a comparatively short time, merely by generating the sequence information so that the changing display screens corresponding to the various presentation patterns may be successively displayed. In this case, regarding the changing display screens whose display contents resemble one another, the sequence information is generated so as to display at least one of the resembling changing display screens, whereby all of the various sorts changing display screens whose display contents differ from one another are permitted to be displayed in a short time.

In a demonstration display method for a game machine according to the present invention, when a start signal has been outputted by a game mechanism, the changing display screen corresponding to one of the presentation patterns is displayed.

In a game machine for a demonstration according to the present invention consisting in the above game machine for a demonstration, wherein when a start signal has been outputted by a game mechanism, the control unit causes the display unit to display the changing display screen corresponding to one of the presentation patterns.

With this demonstration display method for a game machine and this game machine for a demonstration, when the start signal has been outputted by the game mechanism, the changing display screen corresponding to one of the presentation patterns is displayed.

Thus, a demonstrator can experience a game with a feeling as if the player were actually playing a game compared to a method in which the respective changing display screens are automatically displayed irrespective of game states.

In a demonstration display method for a game machine according to the present invention, the sequence information where a plurality of records in which the presentation patterns for demonstratively displaying the fluctuating display screens are registered so as to be specifiable are registered in accordance with the demonstrating sequence, the fluctuating display screens are successively displayed from the fluctuating display screen corresponding to the presentation pattern specified by any designated one of the plurality of records.

A game machine for a demonstration according to the present invention has a storage unit that records therein the sequence information where a plurality of records in which the presentation patterns for demonstratively displaying the fluctuating display screens are registered so as to be specifiable, are registered in accordance with the demonstrating sequence. The game machine also has a control unit that causes the display unit to successively display the fluctuating display screens from the fluctuating display screen corresponding to the presentation pattern specified by any designated one of the plurality of records.

With this demonstration display method for a game machine and this game machine for a demonstration, the changing display screens corresponding to the respective presentation patterns are successively displayed from any predetermined record within the sequence information. Thus, even in a case, for example, where demonstrations are given by arraying a plurality of game machines for demonstrations, the concurrence of changing display screens which are displayed on adjacent game machines for demonstrations is avoided, and each participant is permitted to experience a game with a feeling equivalent to that of an actual game, without recognizing the fact that the changing display screens are displayed in the predetermined sequence.

In a demonstration display method for a game machine according to the present invention, a pattern which is designated by start pattern designation information where the pattern to be displayed at the start of the display of the changing display screen is designated for each of the presentation patterns within the sequence information, is displayed at the start of the display of the changing display screen. A pattern which is designated by the last pattern designation information where the pattern to be displayed at the last of the changing display screen is designated for each of the presentation patterns within the sequence information, is displayed at the last of the changing display screen.

In a game machine for a demonstration according to the present invention, the storage unit records therein start pattern designation information where a pattern to be displayed at the start of the display of each changing display screen is designated, and the last pattern designation information where a pattern to be displayed at the last of each changing display screen is designated, in association with each of the presentation patterns within the sequence information. The control unit causes the display unit to display the pattern designated by the start pattern designation information, at the start of the display of the changing display screen, and to display the pattern designated by the last pattern designation information, at the last of the display of the changing display screen.

With this demonstration display method for a game machine and this game machine for a demonstration, the pattern designated by the start pattern designation information is displayed on the display unit at the start of the display of each changing display screen, and the pattern designated by the last pattern designation information is displayed on the display unit at the last of the changing display screen. Thus, at the shift of the changing display screen to the next one, both the changing display screens are permitted to be smoothly displayed without causing a player to feel uneasy due to the sudden change of a pattern which has been displayed until then.

### BRIEF DESCRIPTION OF THE DRAWINGS

FIG. 1 is a block diagram showing the construction of a pachinko machine.

FIG. 2 is a data structure diagram of a display pattern list D1.

FIG. 3 is a data structure diagram of a table Dt for specifying presentation patterns.

FIG. 4 is a flow chart of a demonstration process.

FIG. 5 is a block diagram showing the construction of a slot machine.

FIG. 6 is a data structure diagram of a display pattern list Dla.

FIG. 7 is a data structure diagram of a table Dta for specifying presentation patterns.

### DETAILED DESCRIPTION

Now, preferred embodiments of a demonstration display method for a game machine and a game machine for a demonstration according to the present invention will be described with reference to the accompanying drawings.

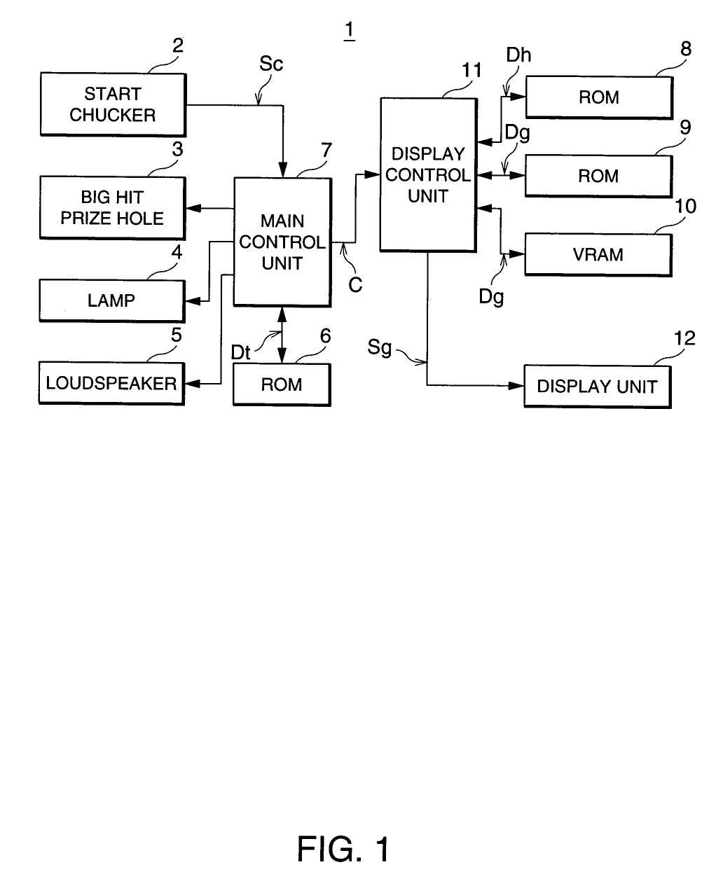

First of all, the construction of a pachinko machine 1 will be described with reference to the drawings. The pachinko machine 1 corresponds to a game machine for a demonstration (a demonstration game machine) according to the present invention and is a pachinko machine for a demonstration (a demonstration pachinko machine) fabricated by remodeling or simulating an actual pachinko machine (actual machine) which is to be installed in a pachinko parlor or the like, and the external appearance and basic internal construction thereof are formed similarly to those of the actual machine. As shown in FIG. 1, the pachinko machine 1 includes a start chucker 2, a big hit prize hole 3, a lamp 4, a loudspeaker 5, ROMs 6, 8, 9, a main control unit 7, a VRAM 10, a display control unit 11 and a display unit 12. In this case, in each of the actual machine and the pachinko machine 1, the three reels (not shown) of a left reel, a right reel and a central reel are displayed on the display unit 12, and the numerals of the respective reels are changed and displayed in conjunction with the hit of the start chucker 2 by a shot ball and are stationarily displayed upon lapse of a predetermined time period, thereby notifying a lottery result to a player. A plurality of presentation patterns exist from the start of the changing displays of the numerals until the stationary displays of these numerals. In particular, there exist, for example, up to 300 or more presentation patterns such as 20 “ordinary changing patterns”, 10 “normal reach miss patterns”, 5 “normal reach hit patterns”, 3 “reach development miss patterns”, 2 “reach development hit patterns” and a “super reach development hit pattern”. Hereinbelow, a series of changing display screens for notifying lottery results that correspond to the individual presentation patterns shall also be termed “animations”. By the way, in the actual machine, the animation to be displayed is sequentially determined on the basis of the lottery result being a predetermined condition in the present invention, whereas in the pachinko machine 1, the display sequence of the animations is predetermined in order to display all the animations as will be described later.

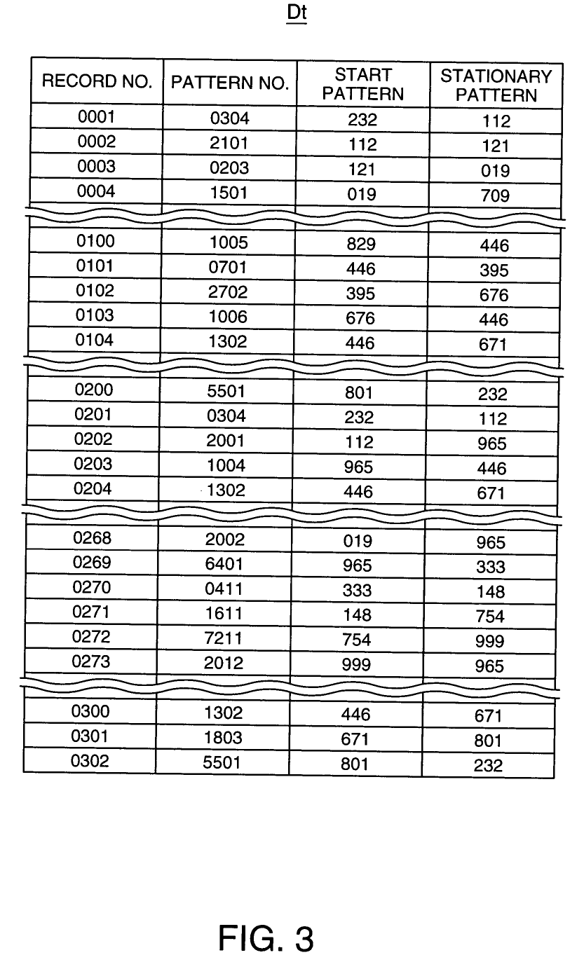

The start chucker 2 outputs a chucker signal Sc, corresponding to a start signal in the present invention, to the main control unit 7 when a shot ball has hit. The big hit prize hole (attacker) 3 is opened by the main control unit 7 in conjunction with the display content (that is, hit pattern) of the animation displayed on the display unit 12. The lamp 4 is lit up in conjunction with a game state under the control of the main control unit 7. The loudspeaker 5 emits various sounds in conjunction with a game state under the control of the main control unit 7. The ROM 6 corresponds to a storage unit in the present invention, and it records therein a table for specifying presentation patterns (also referred to below as “specifying table), Dt and the operation program of the main control unit 7, etc. In this case, the specifying table Dt corresponds to sequence information in the present invention, and it is constituted by a plurality of records, for example, record numbers 0001 to 0302 as shown in FIG. 3. Registered in each record in the specifying table Dt are a pattern number for specifying a presentation pattern relevant to an animation which is displayed in the record, a start pattern for designating patterns which are respectively displayed on the left reel, central reel and right reel at the start of the display of the animation (start pattern designation information in the present invention), and a stationary pattern for designating patterns which are respectively stationarily displayed on the left reel, central reel and right reel (last pattern designation information in the present invention).

The main control unit 7 constructs a control unit in the present invention conjointly with the display control unit 11, and it performs the general control of the whole pachinko machine 1, such as the controls of the operations of the various parts of a game mechanism as includes the big hit prize hole 3, lamp 4 and loudspeaker 5, and the output of a presentation start command C to the display control unit 11 (an instruction concerning the display of an animation, for the display unit 12). When supplied with the chucker signal Sc from the start chucker 2, the main control unit 7 specifies the presentation pattern relevant to the animation to be displayed on the display unit 12, on the basis of the specifying table Dt, and it supplies the display control unit 11 with the presentation start command C which gives the instruction of displaying the animation in accordance with the specified presentation pattern.

The ROM 8 records therein display procedure data Dh in which display methods for animations corresponding to individual presentation patterns are registered, the operation program of the display control unit 11, etc. The ROM 9 records therein pattern data Dg concerning patterns in which numerals to be displayed on the respective reels are depicted. The VRAM 10 is a memory in which the pattern data Dg, Dg . . . are virtually depicted by the display control unit 11 in generating image signals Sg for displaying various animations, and which includes two storage areas (screen buffers) by way of example. In compliance with the presentation start command C outputted by the main control unit 7, the display control unit 11 virtually depicts the patterns corresponding to the pattern data Dg, Dg > . . . in the screen buffers within the VRAM 10, thereby generating the image signals Sg and to successively output them to the display unit 12. Although not especially restricted, the display unit 12 is constructed of, for example, a liquid crystal panel capable of displaying the various animations in color.

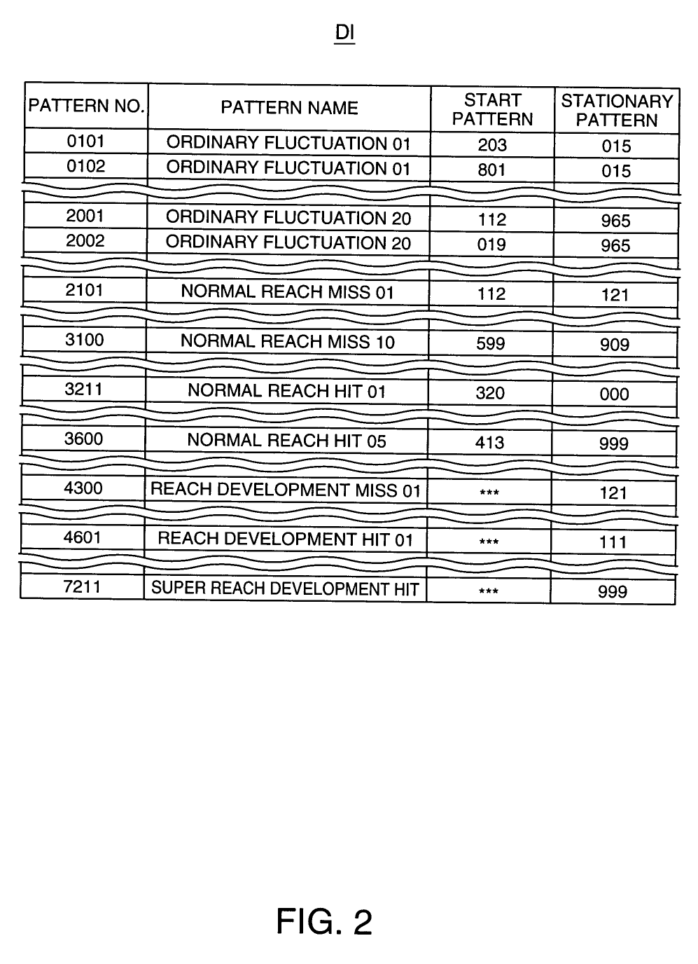

Next, a demonstration method (demonstration display method) based on the pachinko machine 1 will be described with reference to the drawings. In the first place, the specifying table Dt to be record in the ROM 6 is created using, for example, a personal computer. Incidentally, a process for creating the specifying table Dt and a process for recording it in the ROM 6 need not be executed on the occasion of each demonstration based on the pachinko machine 1, but they are executed only once in the first place. In creating the specifying table Dt, display patterns of 1 to 10 sorts or so, in which the combinations of start patterns and stationary patterns are different, are first generated for various presentation patterns approximately up to 300 or more, and pattern numbers are assigned to the respective display patterns, thereby creating a display pattern list Dl shown in FIG. 2. In the display pattern list D1, by way of example, 6 display patterns (pattern numbers 0101 to 0106) having different start patterns are prepared for “ordinary change 01”, 9 display patterns (pattern numbers 2001 to 2009) having different start patterns are prepared for “ordinary change 20”, and one display pattern (pattern number 2101 or 7211) is prepared for each of “normal reach miss 01 (i.e. one away from the target)” and “super reach hit (i.e. again close but miss the target)”. “***” contained at the “start pattern” in the figure signifies that the same pattern as the stationary pattern of the display pattern displayed directly before the corresponding display pattern is displayed.

Subsequently, the display patterns are selected at random from within the display pattern list Dl, thereby creating the specifying table Dt. On this occasion, the display patterns are selected so that the stationary pattern of the display pattern selected directly before may match the start pattern of the display pattern to be selected next. Besides, it is favorable to select from among the display patterns, at least one display pattern which belongs to each sort of presentation pattern (for example, “ordinary change 01”) (in this case, the display pattern of any of pattern numbers 0101-0106).

Further, in selecting the display patterns, miss patterns or hit patterns are intentionally selected to be consecutive, whereby a so-called “wave” can be formed. The display patterns are successively selected in this manner, whereby the specifying table Dt having a plurality of records (for example, 302 records of records 0001-0302) is created as shown in FIG. 3. Thereafter, the created specifying table Dt is recorded in the ROM 6 with a ROM writer, and the ROM 6 is further installed in the pachinko machine 1, whereby preparation for the demonstration based on the pachinko machine 1 is completed.

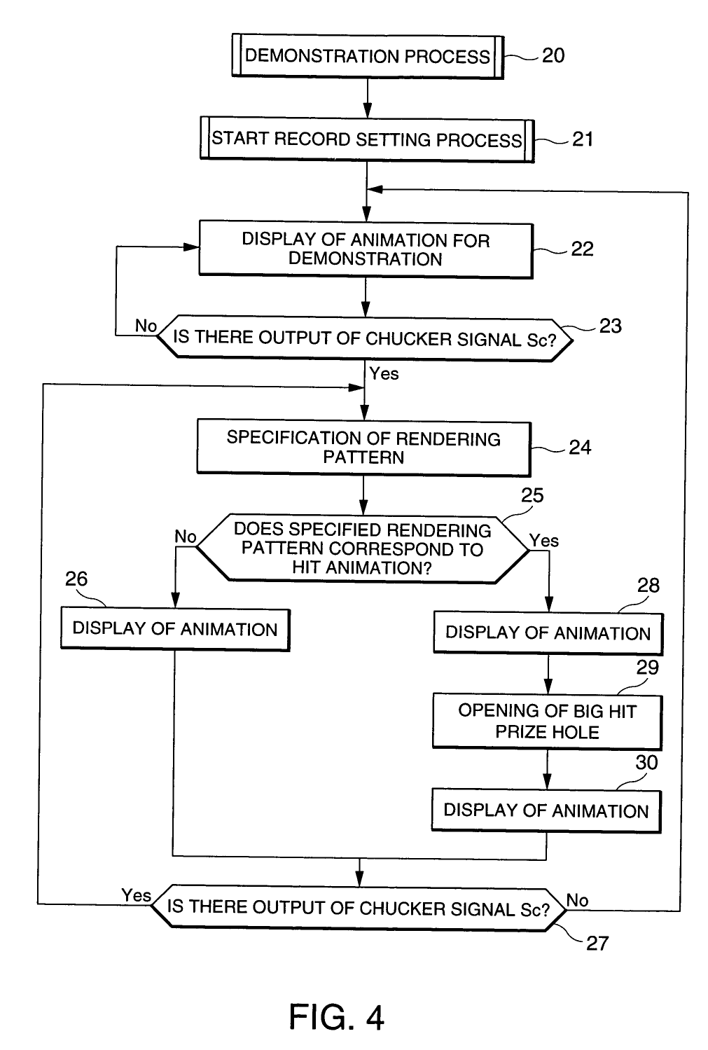

Meanwhile, in giving the demonstration, a demonstration process 20 shown in FIG. 4 is executed by the main control unit 7 and display control unit 11 of the pachinko machine 1. In the demonstration process 20, when the power source of the pachinko machine 1 has been turned ON, the main control unit 7 executes a start record setting process (step 21). In the start record setting process, when supplied with the chucker signal Sc from the start chucker 2, the main control unit 7 allows an operator to set which of the records of the specifying table Dt the display of an animation on the display unit 12 is to be started from. In this case, when demonstrations are given by arraying a plurality of pachinko machines 1, 1 . . . , start records are made different in the respective pachinko machines 1, 1 . . . , whereby even if the demonstrations are started at the same time, the concurrence of animations which are displayed on the respective pachinko machines 1, 1 . . . can be avoided. Subsequently, the main control unit 7 supplies the display control unit 11 with the presentation start command C for displaying an animation for the demonstration (also referred to below as “demonstrational animation”) as is previously determined as the animation to be displayed at the turn-ON of the power source of the pachinko machine 1. In compliance with the command, the display control unit 11 generates the image signal Sg for the demonstrational animation and outputs the generated signal to the display unit 12. In this case, the demonstrational animation is an animation which is displayed on the display unit 12 in a non-gaming state (a state where a player does not exist), and it is repeatedly displayed on the display unit 12 until a shot ball hits the start chucker 2 (step 22).

After outputting the presentation start command C for the demonstrational animation to the display control unit 11, the main control unit 7 continues to monitor whether or not the chucker signal Sc has been outputted from the start chucker 2 (step 23). When the chucker signal Sc has been outputted from the start chucker 2 (when a shot ball has hit the start chucker 2), the main control unit 7 specifies the presentation pattern of an animation to be displayed on the display unit 12, on the basis of the content of a predetermined record (record set at the step 21) in the specifying table Dt (step 24), and it supplies the display control unit 11 with the presentation start command C for displaying the animation with the specified presentation pattern. On this occasion, the main control unit 7 outputs a command instructing a start pattern and a stationary pattern for the animation, together with the presentation start command C. In compliance with the pattern command, the display control unit 11 determines whether or not the instructed presentation pattern (animation) is the animation of a hit (also referred to below as “hit animation”), on the basis of the presentation start command C outputted by the main control unit 7 (step 25).

On this occasion, when the instructed presentation pattern (animation) is a miss animation which is not any hit animation, the display control unit 11 reads out the display procedure data Dh corresponding to the miss animation from the ROM 8, and it reads out the pattern data Dg, Dg . . . necessary for displaying the miss animation, from the ROM 9 and successively records them in the VRAM 10 (causes the VRAM to virtually depict them) in accordance with the display procedure data Dh. Subsequently, the display control unit 11 generates the image signals Sg on the basis of images virtually depicted in the VRAM 10 and successively outputs them to the display unit 12. Thus, the animation (miss animation) corresponding to the presentation start command C is displayed on the display unit 12 (step 26). Meanwhile, the main control unit 7 determines whether or not the chucker signal Sc has been outputted from the start chucker 2 during the display of the miss animation on the display unit 12 (step 27). When the chucker signal Sc does not continue to be outputted from the start chucker 2 for a predetermined time period, the main control unit 7 returns to the step 22 so as to supply the display control unit 11 with the presentation start command C for displaying the demonstrational animation. Thus, the demonstrational animation is displayed on the display unit 12. When the chucker signal Sc has been outputted during the display of the miss animation on the display unit 12, the main control unit 7 returns to the step 24 so as to specify a presentation pattern to be displayed on the display unit 12, on the basis of the content of the next record in the specifying table Dt, and to supply the display control unit 11 with the presentation start command C for displaying the animation with the specified presentation pattern.

On the other hand, when the determined result of the step 25 is the hit animation, the display control unit 11 reads out the corresponding display procedure data Dh and pattern data Dg, Dg . . . from the respective ROMs 8, 9, and it generates the image signals Sg and outputs them to the display unit 12.

Thus, the hit animation corresponding to the presentation start command C is displayed on the display unit 12 (step 28). At the time when a predetermined time period has lapsed since the output of the presentation start command C to the display control unit 11 (at the time when the display of the hit animation has been completed to stationarily display the hit pattern), the main control unit 7 causes the lamp 4 to flicker and causes the loudspeaker 5 to emit a sound notifying the hit. At the same time, the main control unit 7 opens the big hit prize hole 3 (step 29). Subsequently, at the time when a predetermined number of pachinko balls have entered the big hit prize hole 3, or at the time when a predetermined time period stipulated beforehand has lapsed since the time of the opening of the big hit prize hole 3, the main control unit 7 closes the big hit prize hole 3. Subsequently, at the time when the big hit prize hole 3 opens and closes a predetermined number of times (for example, 15 times), the main control unit 7 supplies the display control unit 11 with the presentation start command C for displaying a big hit ending animation (also referred to below as “ending animation”). Thus, the ending animation is displayed on the display unit 12 (step 30).

Subsequently, the main control unit 7 determines whether or not the chucker signal Sc has been outputted from the start chucker 2 during the display of the hit animation as well as the ending animation on the display unit 12 (step 27). When the chucker signal Sc is not being outputted, the main control unit 7 returns to the step 22 so as to display the demonstrational animation. In contrast, when the chucker signal Sc is being outputted, the main control unit 7 returns to the step 24 so as to specify a presentation pattern to be displayed on the display unit 12, on the basis of the content of the next record in the specifying table Dt, and to supply the display control unit 11 with the presentation start command C for displaying a predetermined animation. Whenever the respective chucker signals Sc are outputted from the start chucker 2, animations corresponding to respective records in the specifying table Dt are successively displayed on the display unit 12. Thus, whichever record in the specifying table Dt the display of an animation may be started from, all the animations (presentation patterns) registered in the table Dt for specifying the presentation patterns can be displayed by causing shot balls to hit the start chucker 2 at least 302 times.

In this manner, according to the pachinko machine 1, the main control unit 7 specifies the demonstrating sequence of animations on the basis of the specifying table Dt, and the display control unit 11 successively displays the respective animations on the display unit 12 in the sequence specified by the main control unit 7, whereby animations (presentation patterns) which are displayed at low probabilities can be reliably displayed in a comparatively short time merely by previously creating the specifying table Dt so that the respective animations may be successively displayed. In this case, regarding animations whose display contents resemble one another, the specifying table Dt is created so as to display any of the resembling animations, whereby all of various animations whose display contents differ from one another can be displayed in a short time. When the chucker signal Sc has been outputted from the start chucker 2, the main control unit 7 causes the display control unit 11 to display one animation, whereby a participant in a demonstration can experience a game with a feeling equivalent to that of an actual game when the pachinko machine 1 is compared with a scheme in which the respective animations are successively displayed regardless of whether or not shot balls hit.

The main control unit 7 specifies animations to-be-displayed from any predetermined record of the specifying table Dt and causes the display control unit 11 to display them, whereby even when a plurality of pachinko machines 1, 1 . . . are arrayed for demonstrations by way of example, the concurrence of animations displayed on the pachinko machines 1, 1 . . . adjacent to one another can be avoided, and demonstrators can experience games with feelings equivalent to those of actual games, without the animations being displayed in predetermined sequences. Further, the main control unit 7 outputs the presentation start command C to the display control unit 11 so that a pattern designated by the start pattern in the specifying table Dt may be displayed at the start of the display of an animation, and so that a pattern designated by the stationary pattern may be stationarily displayed. In this way, at the shift of the animation to the next one, both the animations can be smoothly displayed without causing a player to feel odd due to the sudden change of a pattern which has been displayed until then.

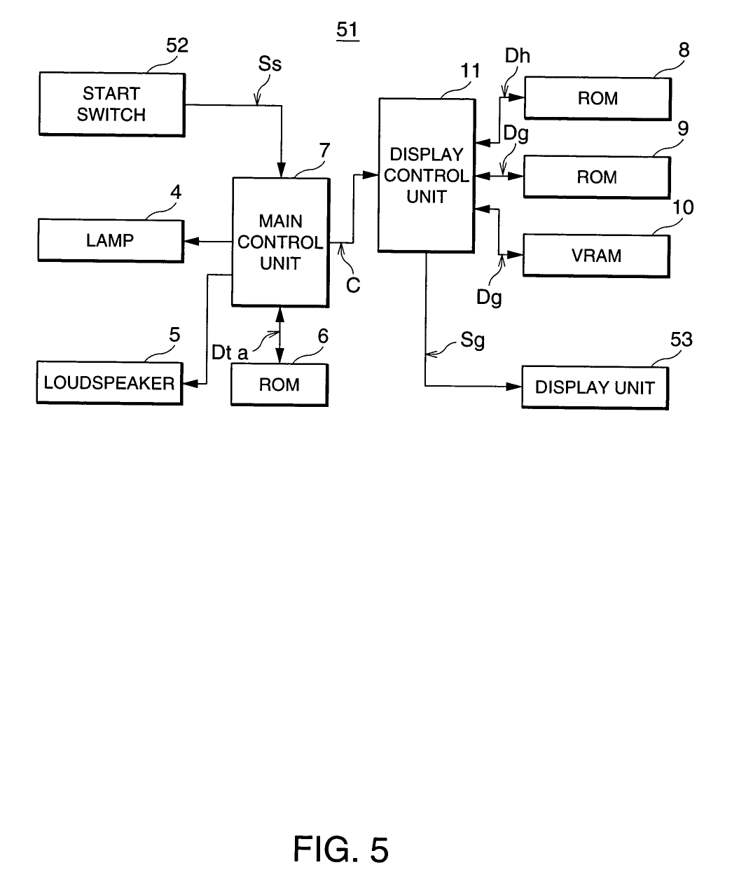

Next, a slot machine 51 according to another embodiment of the present invention will be described with reference to the drawings. Incidentally, the slot machine 51 shown in FIG. 5 corresponds to a game machine for a demonstration (a demonstration game machine) according to the present invention, and the present invention is basically applied as in the pachinko machine 1 described above. Accordingly, the same reference numerals and signs will be assigned to the same constituents as in the pachinko machine 1, and they shall be omitted from repeated description. The slot machine 51 is a slot machine for a demonstration fabricated by remodeling or simulating an actual slot machine (actual machine) which is to be installed in a game hall or the like, and the external appearance and basic internal construction thereof are formed similarly to those of the actual machine. The slot machine 51 is constructed including a start switch 52 which outputs a start signal Ss (start signal) by detecting the manipulation of a handle, and a display unit 53 which displays three reels under the control of a display control unit 11. In this case, in each of the actual machine and the slot machine 51, numerals or patterns on the three reels (slots 1-3) displayed on the display unit 53 are changed and displayed in conjunction with the manipulation of the handle, and they are stationarily displayed upon lapse of a predetermined time period, whereby a lottery result is notified to a player. A plurality of presentation patterns (animations) exist from the start of the changing displays of the numerals or patterns until the stationary displays thereof. By the way, in the actual machine, the animation to be displayed is sequentially determined by a main control unit 7, whereas in the slot machine 51, a display sequence is predetermined in order to display all the animations as will be described later.

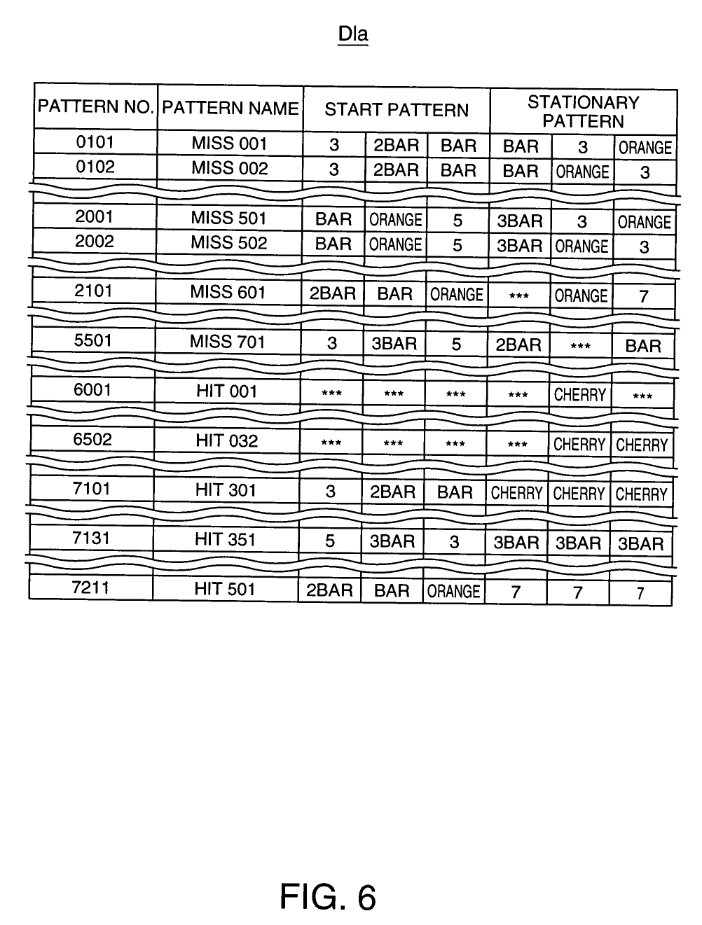

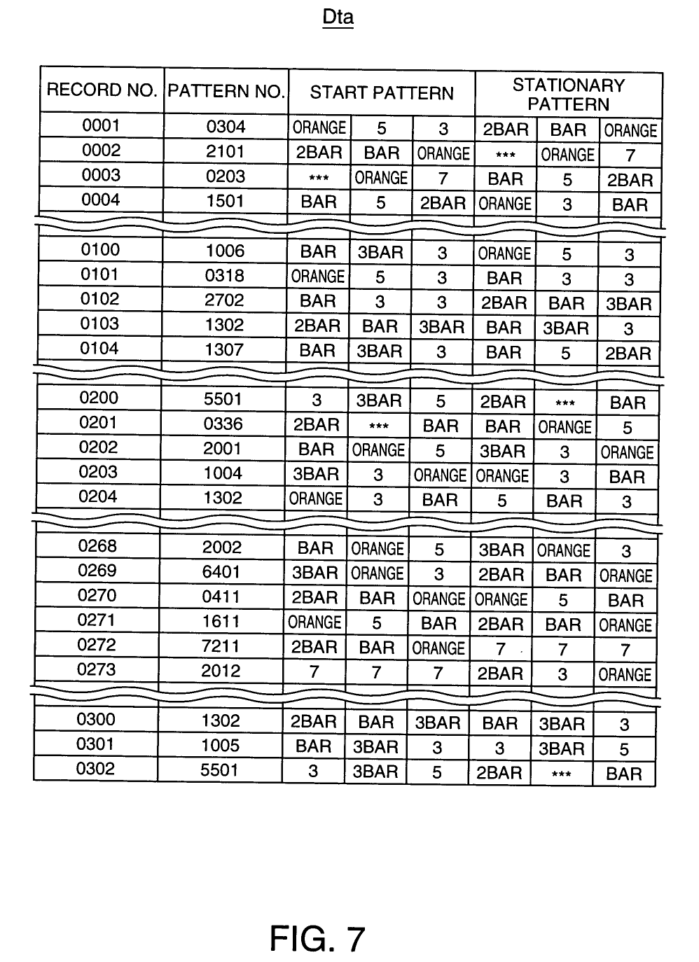

In this case, a ROM 6 records therein a table for specifying presentation patterns (also referred to below as “specifying table), Dta shown in FIG. 7. The specifying table Dta corresponds to sequence information in the present invention, and it is created beforehand by employing a personal computer and is record in the ROM 6, in a similar way to the specifying table Dt record in the ROM 6 of the foregoing pachinko machine 1. In particular, first of all, a display pattern list Dla shown in FIG. 6 is created on the personal computer, and display patterns are selected at random from the created display pattern list Dla, thereby creating the specifying table Dta. Subsequently, the created specifying table Dta is recorded in the ROM 6 with a ROM writer. Thus, the specifying table Dta which is composed of a plurality of records of, for example, record numbers 0001 to 0302 are recorded in the ROM 6, whereby preparation for the demonstration based on the slot machine 51 is completed. Registered in each record in the specifying table Dta are a pattern number for specifying a presentation pattern relevant to an animation which is displayed in the record, a start pattern for designating patterns which are respectively displayed on the left reel, central reel and right reel at the start of the display of the animation (start pattern designation information in the present invention), and a stationary pattern for designating patterns which are respectively stationarily displayed on the left reel, central reel and right reel (last pattern designation information in the present invention).

Meanwhile, in giving the demonstration, the main control unit 7 continues to monitor whether or not the start signal Ss has been outputted from the start switch 52. When the start signal Ss has been outputted from the start switch 52 (when the handle or spin button has been manipulated), the main control unit 7 specifies the presentation pattern of an animation to be displayed on the display unit 53, on the basis of the content of a predetermined record (an example of “any designated record” in the present invention: record 0100, for example, in this case) in the specifying table Dta, and it supplies the display control unit 11 with a presentation start command C for displaying the animation with the specified presentation pattern. On this occasion, the main control unit 7 outputs a command instructing a start pattern and a stationary pattern for the animation, together with the presentation start command C. In compliance with the pattern command, the display control unit 11 determines whether or not the instructed animation is the animation of a hit, on the basis of the presentation start command C outputted by the main control unit 7. When the instructed animation is a miss animation, the display control unit 11 reads out display procedure data Dh corresponding to the miss animation from a ROM 8, and it reads out pattern data Dg, Dg . . . necessary for displaying the miss animation, from a ROM 9 and successively records them in a VRAM 10 (causes the VRAM to virtually depict them) in accordance with the display procedure data Dh. Subsequently, the display control unit 11 generates image signals Sg on the basis of images virtually depicted in the VRAM 10 and successively outputs them to the display unit 53. Thus, the animation corresponding to the presentation start command C (in this case, the miss animation stationarily displayed by “Orange”, “5” and “3”) is displayed on the display unit 53.

Subsequently, the main control unit 7 monitors again whether or not the start signal Ss has been outputted from the start switch 52. When the start signal Ss is outputted, the main control unit 7 specifies an animation to be displayed on the display unit 53, on the basis of the content of the next record (record 0101 in this case) in the specifying table Dta, and it supplies the display control unit 11 with the presentation start command C for displaying the animation. Thus, the animation corresponding to the presentation start command C is displayed on the display unit 53 under the control of the display control unit 11. Thereafter, each time the start signal Ss is outputted from the start switch 52, the main control unit 7 outputs the presentation start command C to the display control unit 11, and the display control unit 11 displays an animation on the display unit 53 in compliance with the presentation start command C outputted by the main control unit 7. Thus, when the presentation start command C corresponding to the content of, for example, a record 0272 has been outputted to the display control unit 11 by the main control unit 7, an animation in which numerals “7”, “7”, “7” are stationarily displayed is displayed on the display unit 53. At the time when a predetermined time period has lapsed since the output of the presentation start command C to the display control unit 11 (at the time when the display of the hit animation has been completed to stationarily display the hit pattern), the main control unit 7 causes a lamp 4 to flash and causes a loudspeaker 5 to emit a sound notifying the hit.

When the respective start signals Ss are outputted from the start switch 52, animations corresponding to respective records in the specifying table Dta are successively displayed on the display unit 53. Thus, whichever record in the specifying table Dta the display of an animation may be started from, all the animations (presentation patterns) registered in the table Dta for specifying the presentation patterns are displayed by handle operation at least 302 times.

In this manner, according to the slot machine 51, as in the foregoing pachinko machine 1, animations (presentation patterns) which are displayed at low probabilities can be reliably displayed in a comparatively short time merely by previously creating the specifying table Dta so that the respective animations may be successively displayed. In this case, regarding animations whose display contents resemble one another, the specifying table Dta is created so as to display any of the resembling animations, whereby all of various animations whose display contents differ from one another can be displayed in a short time.

A participant in a demonstration can experience a game with a feeling equivalent to that of an actual game when the slot machine 51 is compared with a scheme in which the respective animations are successively displayed irrespective of the presence or absence of the handle operation.

Incidentally, the present invention is not restricted to the embodiments of the present invention as described above. By way of example, in the embodiments of the present invention, there have been described the examples in which the pachinko machine 1 and the slot machine 51 having the same constructions as those of the actual machines are used for the demonstrations. However, the game machine for a demonstration according to the present invention is not restricted to such a construction, but it can also be constructed, for example, so that all or some of the ROMs 6, 8, 9, main control unit 7, VRAM 10 and display control unit 11 are replaced with a personal computer so as to display various animations on the display unit 12 or 53. Although the pachinko machine 1 and the slot machine 51 have been exemplified in the embodiments of the present invention, the present invention is applicable to game machines for demonstrations directed toward, not only pachinko machines, but also in a pachislo game, an arcade game and other.

The entire disclosure of Japanese Patent Application Nos. 2002-191087 filed Jun. 28, 2002 and 2003-080725 filed Mar. 24, 2003 are incorporated by reference herein.

What is claimed is:

1. A demonstration display method for a game machine comprising the steps of:
displaying a changing display screen on a display unit, wherein said changing display screen corresponds to a presentation pattern which is determined from among a number of presentation patterns, based on predetermined conditions;
identifying a presentation sequence of said presentation pattern, based on record sequence information; and
successively displaying said changing display screen on said display unit, wherein said changing display screen corresponds to each presentation pattern, based on the predetermined presentation sequence.

2. A demonstration display method for a game machine as defined in claim 1, further comprising the step of displaying said changing display screen, which corresponds to one of said presentation patterns when a start signal is outputted by a game mechanism.

3. A demonstration display method for a game machine as defined in claim 1, further comprising the steps of:
using the sequence information where a plurality of records, in which said presentation pattern for demonstratively displaying said changing display screens is registered so as to be specifiable, are registered in accordance with said demonstrating sequence;
successively displaying said changing display screen corresponding to the presentation pattern specified by any designated one of the plurality of records.

4. A demonstration display method for a game machine as defined in claim 1, further comprising the steps of
displaying a pattern, which is designated by start pattern designation information where the pattern to be displayed at a start of the display of the display screen for each of said presentation patterns within said sequence information at the start of said display of said display screen; and
displaying a pattern, which is designated by a last pattern designation information where the pattern to be displayed last of said display screen for each of said presentation patterns within said sequence information at the last of said display screen.

5. A game machine for a demonstration comprising:
a display unit that displays a changing display screen on a display unit, wherein said changing display screen corresponds to a presentation pattern that is determined based on predetermined conditions from among a number of presentation patterns;
a storage unit that records sequence information, in which a sequence of presentation of each said presentation pattern is recorded; and
a control unit that makes said display unit successively display said changing display screen, wherein said changing display screen corresponds to each said presentation pattern, according to a specified presentation sequence based on the sequence information.

6. A game machine for a demonstration as defined in claim 5, wherein when a start signal has been outputted by a game mechanism,
said control unit causes said display unit to display the changing display screen corresponding to one of said presentation patterns.

7. A game machine for a demonstration as defined in claim 5, wherein said storage unit records therein said sequence information where a plurality of records, in which said presentation patterns for demonstratively displaying said changing display screens are registered so as to be specifiable, are registered in accordance with said demonstrating sequence, and wherein said control unit causes said display unit to successively display said changing display screens from the changing display screen corresponding to the presentation pattern specified by any designated one of the plurality of records

8. A game machine for a demonstration as defined in claim 5, wherein said storage unit records therein start pattern designation information where a pattern to be displayed at a start of the display of said each changing display screens is designated, and a last pattern designation information where a pattern to be displayed last of said each changing display screen is designated, in association with each of said presentation patterns within said sequence information, and said control unit causes said display unit to display the pattern designated by the start pattern designation information, at the start of the display of the changing display screen, and to display the pattern designated by the last pattern designation information, at the last of the display of said changing display screen.

9. A demonstration display method for a game machine comprising the steps of:
sequentially displaying a plurality of changing display screens on a display unit, a sequence of display corresponding to a presentation pattern determined from among a plurality of predetermined presentation patterns;
determining if a start signal outputted by a game mechanism has been received;
if said start signal has been received, sequentially displaying said plurality of changing display screens on said display unit, the sequence of display corresponding to a play of said game mechanism;
determining if the play of said game mechanism has stopped; and
if the play of said game mechanism has stopped, returning the sequence of display to a presentation pattern determined from among the plurality of predetermined presentation patterns.
